(19) United States
(12) Patent Application Publication
(10) Pub. No.: US 2007/0123320 A1
(43) Pub. Date: May 31, 2007

(54) Key input device for portable terminal

(75) Inventors: Seung-Woo Han, Seoul (KR); Kyu-Sub Kwak, Seoul (KR); Kyung Wan Park, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/432,066

(22) Filed: May 11, 2006

(30) Foreign Application Priority Data
Nov. 30, 2005 (KR) 2005-116002

(51) Int. Cl. H04M 1/00

(52) U.S. Cl. 455/575.1

(57) ABSTRACT

A key input device for a portable terminal includes wheel keys capable of rotating in multiple directions and performing a switch function. The key input device including a plurality of keys having at least one wheel keys provided in a main body and rotating in multiple directions, at least one rotating units allowing the wheel keys to rotate in respective directions, and at least one switching units provided under the wheel keys to sense the rotation directions of the wheel keys and to sense a pressure generated by the activation of the rotated wheel keys.

### CLAIM OF PRIORITY

This application claims priority under 35 U.S.C. § 119 to an application entitled “Key Input Device for Portable Terminal,” filed in the Korean Intellectual Property Office on Nov. 30, 2005 and assigned Serial No. 2005-116002, the entire contents of which are hereby incorporated by reference.

### BACKGROUND OF THE INVENTION

1. Field of the Invention

The present invention generally relates to a key input device for a portable terminal and in particular, to a key input device having wheel keys capable of rotating in multiple directions to perform various switch functions.

2. Description of the Related Art

Generally, a portable communication apparatus enables a user to perform a wireless communication with another user. Examples of such portable communication apparatus include Hand Held Phones (HHPs), CT-2 cellular phones, digital phones, Personal Communication Service (PCS) phones, and Personal Digital Assistants (PDAs). The conventional portable devices may be classified into different types, for example, bar-type wireless terminals, flip-type wireless terminals, and folder-type wireless terminals. The bar-type wireless terminal has a single housing. The flip-type wireless terminal has a flip or a cover which is pivotally mounted to a bar-shaped housing via a hinge unit. The folder-type wireless terminal has a folder coupled to a single bar-shaped housing using a hinge unit to allow the folder to be rotated from the housing. These aforementioned conventional portable terminals further include antenna devices, data input/output devices, and data transmission/reception devices.

The conventional portable terminals offer multiple functions to meet consumers' demands and becoming smaller. Today, users can perform voice communication, listen to the radio, connect to the Internet to download MP3 music files, and exchange text messages by manipulating key buttons.

A keypad used for data input typically includes a plurality of keys such as a send key (SND), a cancel key, a clear key (CLR), numeric keys, character keys, an end key (END), functional keys, and a power key (PWR).

The key array generally includes 15-20 keys disposed on a top surface of a housing of a portable terminal. The keys are exposed on the top surface of the portable terminal so that a user can activate them with his/her finger to input desired data.

Referring to FIGS. 1 and 2, a conventional folder-type portable terminal includes a main body 10 and a folder 20. In the main body 10, keys 12, a four-direction control key 11, and a microphone 13 are mounted. The folder 20 provides a Liquid Crystal Display (LCD) unit 21 and a speaker 22. A hinge device 30 is provided between the main body 10 and the folder 20 to rotate upwardly from the main body 10. An antenna 40 is provided on the main body 10. The keys 12 are in the form of a key matrix including the twelve 3×4 keys 12 and the four-direction control key 11.

In the main body 10, a plurality of through holes 14 are formed for pass-through connection between the keys 12 and the four-direction control key 11. A partition 15 is formed between each pair of through holes 14 to form the 3×4 key matrix. A plurality of dome switches 60 is provided on a Printed Circuit Board (PCB) 50 including circuits in the main body 10. A signal is generated through a contact between a contact point 51 of the PCB 50 and a contact point 61 of the dome switch 60.

As illustrated in FIG. 2, the dome switch 60 is provided on the PCB 50 to output a contact signal according to key activation by the user. The keys 12 and the four-direction control key 11 including up/down/left/right direction keys for various functions are provided on the dome switches 60. Since the main body of the conventional portable terminal includes twelve keys and a four-direction control key, the exterior design of the portable terminal is restricted due to multiple keys on the portable terminal.

Moreover, in the case of the conventional portable terminal, a current graphic user interface is designed to be controlled by a keypad having a plurality of keys, and the conventional graphic user interface uses icon-based information rather than text-based information. To select such icon-based information, an interface between the portable terminal and the user must be made using the four-direction control key.

In the conventional portable terminal, a user interface for interfacing with the user evolves into a graphic user interface, but only separate keys can control the graphic user interface. As a result, the lack of user's intuition occurs due to key pressing, and the user must press the four-direction control key to achieve the movement of an iconized menu screen in different directions, causing inconvenience of manipulation. Furthermore, the plurality of keys on the portable terminal makes miniaturization of the portable terminal difficult, and miniaturization of the keys interferes with the usage by a user.

### SUMMARY OF THE INVENTION

It is, therefore, an object of the present invention to provide an improved key input device for a portable terminal including wheel keys capable of rotating in multiple directions and performing multiple switch functions.

One aspect of the present invention to provide a key input device for a portable terminal including wheel keys capable of rotating in multiple directions and performing multiple switch functions, in which an iconized menu screen can be moved rapidly.

Another aspect of the present invention to provide a key input device for a portable terminal including wheel keys capable of rotating in multiple directions and performing multiple switch functions, in which there is no need to mount a four-direction control key, thereby reducing a key installing space in the portable terminal. As a result, a further miniaturization of the portable terminal can be realized.

Yet another aspect of the present invention to provide a key input device for a portable terminal including wheel keys capable of rotating in multiple directions and performing multiple switch functions, in which a movement in various directions can be made using keys, thereby reducing errors during key operation.

In one embodiment, there is provided a key input device for a portable terminal including a plurality of keys. The key input device includes at least one wheel keys provided in a main body and rotating in multiple directions, at least one rotating units allowing the wheel keys to rotate in respective directions, and at least one switching units provided under the wheel keys to sense rotation directions of the wheel keys and sense a pressure generated by press of the rotated wheel keys.

### BRIEF DESCRIPTION OF THE DRAWINGS

The above features and advantages of exemplary embodiments of the present invention will be more apparent from the following description taken in conjunction with the accompanying drawings, in which:

FIG. 1 is a perspective view showing a folder of a conventional folder-type portable terminal is opened;

FIG. 2 is a cross-sectional view taken along a line A-A′ of FIG. 1;

FIG. 3 is a perspective view of a key input device of a portable terminal according to an embodiment of the present invention;

FIG. 4 is an enlarged exploded perspective view of a portion A of FIG. 3;

FIG. 5 is a perspective view showing a key input device in a portable terminal according to an embodiment of the present invention;

FIG. 6 is an enlarged partially-cut perspective view showing a key input device according to an embodiment of the present invention;

FIG. 7 is an enlarged plane view showing a key input device according to an embodiment of the present invention;

FIG. 8 is an enlarged side cross-sectional view showing a key input device according to an embodiment of the present invention; and

FIG. 9 is a plane view showing a key input device of a portable terminal during operation in accordance with an embodiment of the present invention.

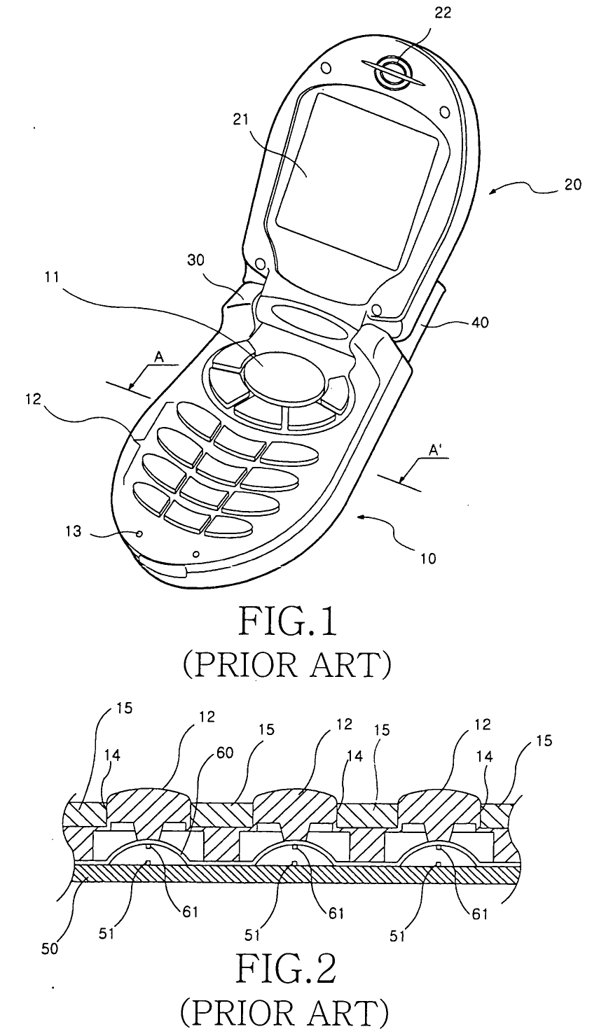

### DETAILED DESCRIPTION

Hereinafter, descriptions of well-known functions and constructions are omitted for clarity and simplicity.

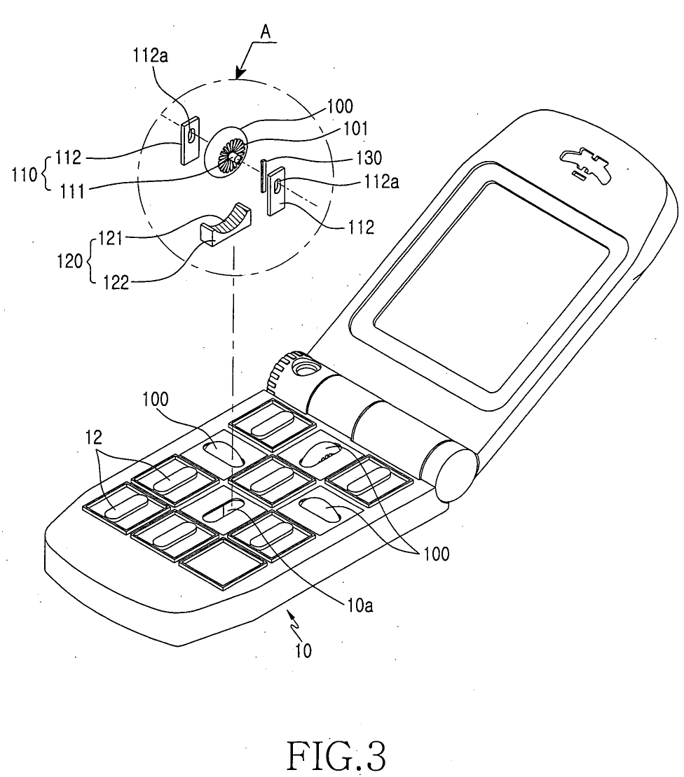

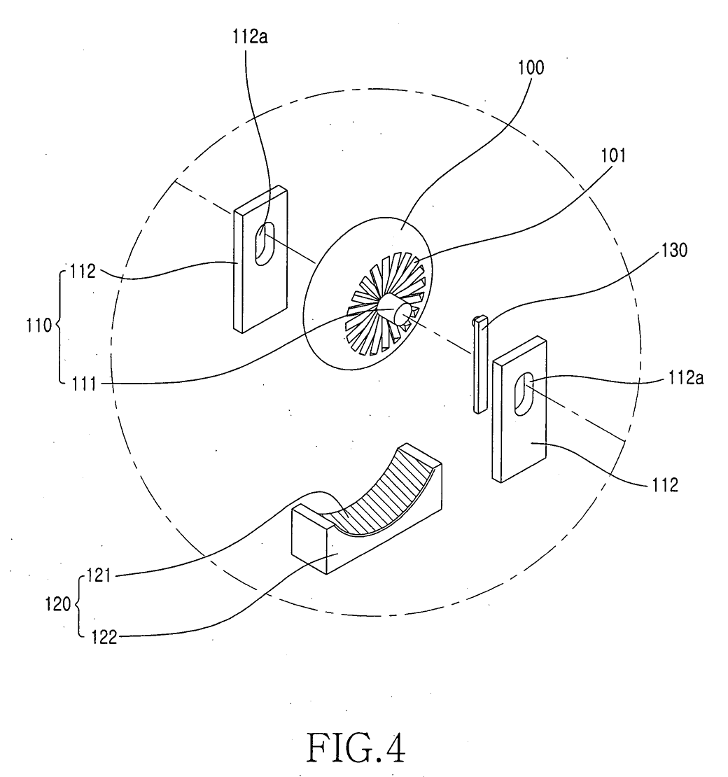

Referring to FIGS. 3 and 4, a key input device for a portable terminal includes at least one wheel keys 100, at least one rotating units 110, and at least one switching units 120. The wheel keys 100 are included in a main body 10 of the portable terminal to rotate in up/down/left/right directions. The rotating unit 110 is located adjacent to the wheel key 100 to allow the wheel key 100 to rotate in up/down/left/right directions. The switching unit 120 is located under the wheel key 100 to sense the rotation direction of the wheel key 100 and sense a pressure generated by user's press when being rotated.

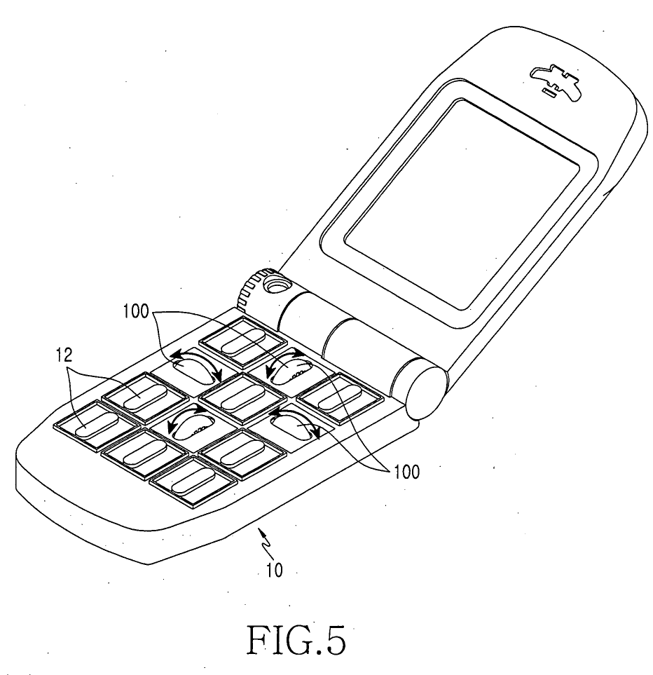

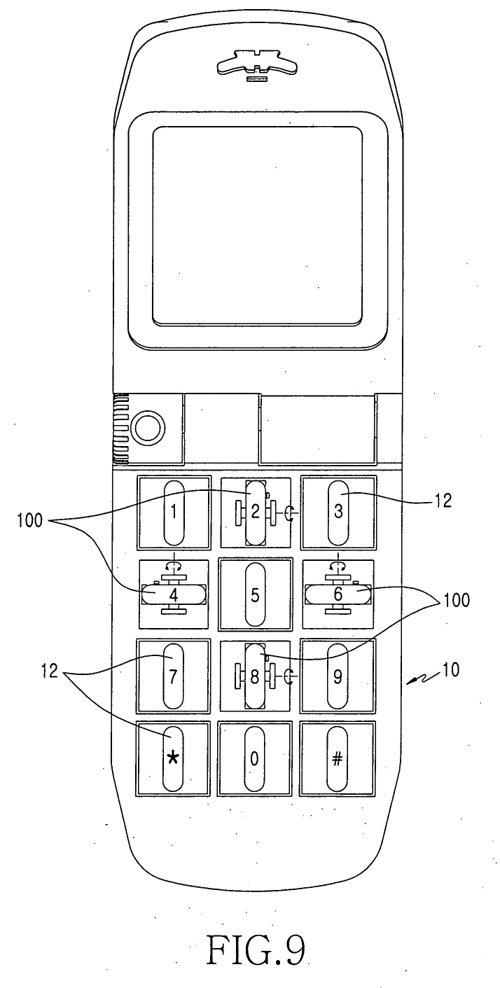

Referring to FIGS. 5 and 9, the wheel keys 100 are mounted in positions corresponding to keys 12 numbered 2, 4, 6, and 8 in a 3×4 key matrix of a keypad. The wheel keys 100 in the positions of the 2 and 8 keys can rotate in up/down directions, and the wheel keys 100 in the positions of the 4 and 6 keys can rotate in left/right directions.

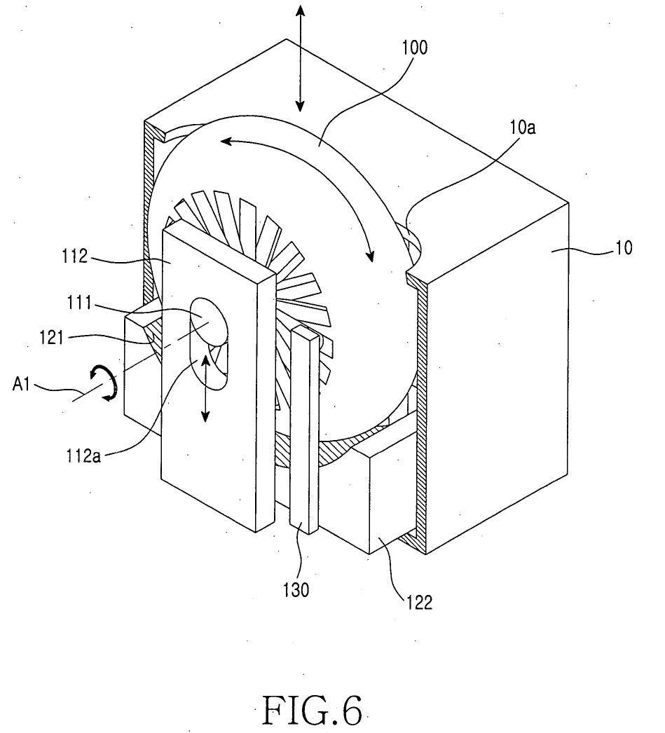

Referring to FIGS. 4 and 6, the rotating unit 110 includes a pair of rotating rollers 111 and a pair of rotating supports 112. The rotating roller 111 protrudes from the center of the wheel key 100 to be combined with the rotating support 112 such that the rotating roller 111 can rotate with respect to its rotating axis A1. The rotating support 112 is located adjacent to the rotating roller 111 to be combined with a guide hole of the rotating roller 111 such that the rotating support 112 can rotate with respect to the rotating axis A1 of the rotating roller 111 and support the rotating roller 111.

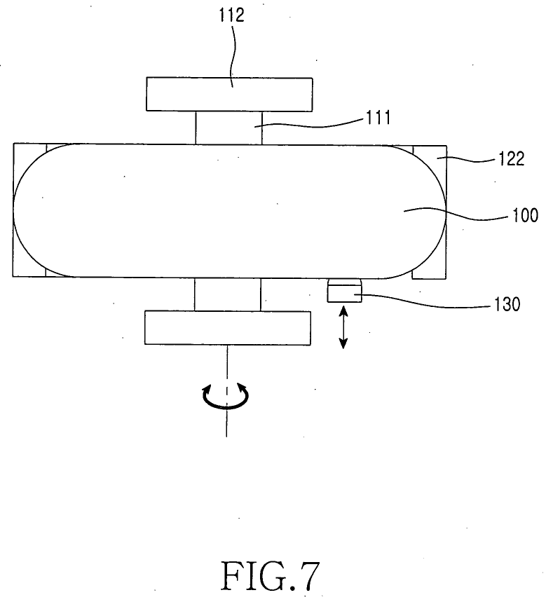

Referring to FIGS. 6 and 7, a click unit 130 is located adjacent to the rotating support 112 to provide the sense of rotational clicking during rotation of the wheel key 100 by contacting a sawtooth unit 101 formed in one side of the wheel key 100.

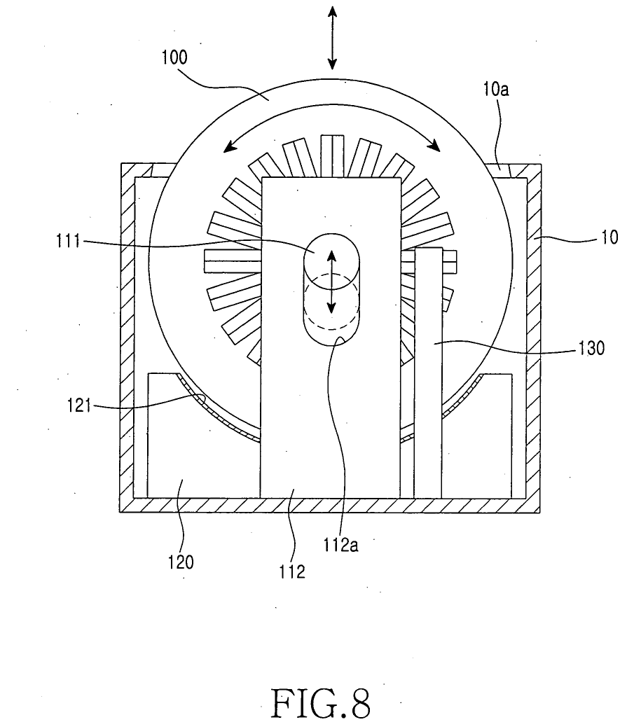

Referring to FIG. 8, the rotating support 112 includes a guide hole 112a for guiding a movement of the rotating roller 111 of the wheel key 100 to a direction in which the wheel key 100 is pressed.

Referring to FIGS. 6 and 8, the switching unit 120 includes a first sensor 121 and a second sensor 122. The first sensor 121 electrically contacts the circumference of the wheel key 100 to sense the rotation direction of the wheel key. The second sensor 122 is located under the first sensor 121 to sense the pressure generated by user's activation of the wheel key 100.

Referring to FIG. 3, at least one protruding holes 10a are formed on the surface of the main body 10 to allow the wheel key 100 to protrude from the surface of the main body 10.

Now, the operation of the key input device of the portable terminal according to an embodiment of the present invention will be described in detail with reference to FIGS. 3 through 9.

As illustrated in FIGS. 3 and 4, the key input device of the portable terminal includes at least one wheel keys 100, at least one rotating units 110, and at least one switch units 120.

As illustrated in FIG. 9, the key input device includes a keypad having a 3×4 key matrix, and the wheel keys 100 are mounted in positions of the 2, 4, 6, and 8 keys 12 in the 3×4 key matrix. The wheel keys 100 in the positions of the 2 and 8 keys 12 can rotate in up/down directions, and the wheel keys 100 in the positions of the 4 and 6 keys 12 can rotate in left/right directions. Note that the wheel keys 100 may also be mounted in positions of other keys 12.

Since the rotating roller 111 protrudes from the center of the wheel key 100, and the rotating support 112 is located adjacent to the rotating roller 111 to be combined with a guide hole of the rotating roller 111 such that the rotating support 112 can rotate with respect to the rotating axis A1 of the rotating roller 111 and support the rotating roller 111, as illustrated in FIG. 6. The rotating roller 111 can be rotatably combined by the rotating support 112. The rotating support 112 includes the guide hole 112a into which the rotating roller 111 is inserted.

Referring to FIGS. 6 through 8, the click unit 130 is located adjacent to the rotating support 112 to be combined with the sawtooth unit 101 formed in one side of the wheel key 100. Thus, the rotating roller 111 of the wheel key 100 is inserted into the guide hole 112a of the rotating support 112, and the sawtooth unit 101 of the wheel key 100 is combined with the click unit 130.

The switching unit 120 is located under the wheel key 100 as illustrated in FIG. 9.

In this state, to move to an icon (not shown) displayed on a Liquid Crystal Display (LCD) unit 21 of the portable terminal in up/down directions, the user rotates the wheel key 100 in the position of the 2 or 8 key 12 in up/down directions.

Thus, as illustrated in FIG. 6, the wheel key 100 rotates together with the rotation of sawtooth unit 101 of the wheel key 100, in which the sawtooth unit 101 is inserted into and drawn out from the click unit 130 to provide the sense of rotational click of the wheel key 100.

Since the first sensor 121 that electrically contacts the circumference of the wheel key 100 is included in the switching unit 120, the first sensor 121 senses up/down rotation directions of the wheel key 100 upon rotation of the wheel key 100.

Upon reaching a desired icon (not shown) in the display 21, the user presses the wheel key 100. At this time, the second sensor 122 under the first sensor 121 senses a pressure generated by user's press of the wheel key 100. The second sensor 122 senses the pressure and clicks the desired icon through a switch function.

When the wheel key 100 moves in the pressed direction, the rotating roller 111 of the wheel key 100 also moves along the guide hole formed in the rotating support 112.

As illustrated in FIG. 9, to move to an icon (not shown) displayed on the LCD unit 21 of the portable terminal in left/right directions, the user rotates the wheel key 100 in the position of the 4 or 6 key 12 in left/right directions.

As illustrated in FIG. 9, the wheel key 100 rotates together with the rotation of sawtooth unit 101 of the wheel key 100, and the sawtooth unit 101 is inserted into and drawn out from the click unit 130 to provide the sense of rotational clicking of the wheel key 100.

Since the first sensor 121 that electrically contacts the circumference of the wheel key 100 is included in the switching unit 120, the first sensor 121 senses left/right rotation directions of the wheel key 100 upon rotation of the wheel key 100.

Upon reaching the desired icon (not shown), the user presses the wheel key 100. At this time, the second sensor 122 under the first sensor 121 senses a pressure generated by user's press of the wheel key 100. The second sensor 122 senses the pressure and clicks the desired icon through a switch function.

As described above, according to the present invention, by using a key input device for a portable terminal, which includes wheel keys capable of rotating in up/down/left/right directions and performing various switch functions, a key input function of the portable terminal can be improved and an iconized menu screen can be moved rapidly. Moreover, there is no need to mount a conventional four-direction control key, thereby reducing a key installing space, and thus contributing to a miniaturization of the portable terminal.

While the present invention has been shown and described with reference to preferred embodiments thereof, it will be understood by those skilled in the art that various changes in form and details may be made therein without departing from the spirit and scope of the invention. For example, the present invention is applicable to all portable terminals.

What is claimed is:

1. A key input device for a portable terminal including a plurality of keys, comprising:
at least one wheel key for rotating in multiple directions;
at least one rotating unit allowing the least one wheel key to rotate in respective directions; and
at least one switching unit provided under the at least one wheel key to sense rotation directions of the at least one wheel key and to sense a pressure generated by activation of the rotated wheel key by a user.

2. The key input device of claim 1, wherein the at least one wheel key is mounted in positions of 2, 4, 6, and 8 key buttons of a 3×4 key matrix button configuration.

3. The key input device of claim 1, wherein the at least one wheel key in the positions of the 2 and 8 key buttons can rotate in up/down directions, and the least one wheel key in the positions of the 4 and 6 key buttons can rotate in left/right directions.

4. The key input device of claim 1, wherein the least one rotating unit comprises:
a pair of rotating rollers protruding from the center of the least one wheel key; and
a pair of rotating supports located adjacent to the rotating rollers to rotate with respect to the rotating axis of the rotating rollers and to support the rotating rollers.

5. The key input device of claim 4, further comprising a click unit located adjacent to the rotating support to provide the sense of rotational clicking during a rotation of the least one wheel key by contacting a sawtooth unit formed in one side of the wheel key.

6. The key input device of claim 4, further comprising a guide hole formed in the rotating support to guide a movement of the rotating roller of the least one wheel key to a direction in which the least one wheel key is pressed.

7. The key input device of claim 1, wherein the least one switching unit comprises:
a first sensor electrically contacting the circumference of the least one wheel key to sense the rotation direction of the least one wheel key; and
a second sensor located under the first sensor to sense a pressure generated by press of the least one wheel key.

8. The key input device of claim 1, wherein at least one protruding hole for allowing the least one wheel key to protrude from the surface of a main body of the portable terminal is formed on the surface of the main body.

9. A key input device for a portable terminal including a keypad having a plurality of keys, comprising: at least one wheel key provided in the portable terminal to rotate in multiple directions and to sense rotation directions or a pressure generated by pressing of the at least one wheel key.

10. A method of providing a plurality of key buttons for a portable terminal, comprising:
providing at least one wheel key for rotating in multiple directions;
providing at least one rotating unit allowing the at least one wheel key to rotate in respective directions; and
providing at least one switching unit provided under the wheel keys to sense rotation directions of the least one wheel key and to sense a pressure generated by activation of the rotated wheel key by a user.

11. The method of claim 10, wherein the least one wheel keys is mounted in positions of 2, 4, 6, and 8 key buttons of a 3×4 key matrix button configuration.

12. The method of claim 10, wherein the least one wheel key in the positions of the 2 and 8 key buttons can rotate in up/down directions, and the least one wheel key in the positions of the 4 and 6 key buttons can rotate in left/right directions.

13. The method of claim 10, further comprising providing, to the least one rotating unit, a pair of rotating rollers protruding from the center of the least one wheel key; and a pair of rotating supports located adjacent to the rotating rollers to rotate with respect to the rotating axis of the rotating rollers and to support the rotating rollers.

14. The method of claim 13, further comprising providing a click unit located adjacent to the rotating support to provide the sense of rotational clicking during a rotation of the least one wheel key by contacting a sawtooth unit formed in one side of the wheel key.

15. The method of claim 13, further comprising providing a guide hole formed in the rotating support to guide a movement of the rotating roller of the least one wheel key to a direction in which the least one wheel key is pressed.

16. The method of claim 10, further comprising providing, to the least one switching unit, a first sensor electrically contacting the circumference of the least one wheel key to sense the rotation direction of the least one wheel key; and a second sensor located under the first sensor to sense a pressure generated by press of the least one wheel key.

17. The method claim 10, further comprising providing at least one protruding hole for allowing the least one wheel key to protrude from the surface of a main body of the portable terminal is formed on the surface of the main body.
